(19) United States
(12) Patent Application Publication
(10) Pub. No.: US 2011/0246123 A1
(43) Pub. Date: Oct. 6, 2011

(54) PERSONAL STATUS MONITORING

(75) Inventors: James J. DelloStritto, Jordan, NY (US); Albert Goldfain, Tonawanda, NY (US); Min Xu, Cortland, NY (US)

(73) Assignee: WELCH ALLYN, INC., Skaneateles Falls, NY (US)

(21) Appl. No.: 12/907,854

(22) Filed: Oct. 19, 2010

Related U.S. Application Data
(60) Provisional application No. 61/319,192, filed on Mar. 30, 2010.

(51) Int. Cl. G06F 19/00; G01P 15/00

(52) U.S. Cl. 702/141; 73/488

(57) ABSTRACT

A method for monitoring kinetic motion includes: capturing acceleration data of a human body of interest from a plurality of points on the human body of interest; using the plurality of points that correlate to parts of the human body of interest to determine a position or view of the human body of interest, wherein the position or view includes a kinetic signature comprising motion characteristics; and displaying a live representation of the human body of interest by using the determined position or view of the human body of interest.

### RELATED APPLICATION

This application claims the benefit of U.S. Patent Application Ser. No. 61/319,192 filed on Mar. 30, 2010, the entirety of which is hereby incorporated by reference.

### STATEMENT REGARDING FEDERALLY FUNDED RESEARCH OR DEVELOPMENT

These inventions were made with government support under Contract Nos. W81XWH-10-C-0159 and W81XWH-07-01-608 awarded by the United States Army Medical Research Acquisition Activity. The government may have certain rights in these inventions.

### BACKGROUND

Monitoring the status of one or more individuals can provide benefits with respect to improving direction and assistance to those individuals. Use of cameras and other video capture equipment can provide useful information, especially within the pre-determined confines of a building or operating facility. Obtaining video-equivalent information outside of such a facility and over a wide geographic area can become impractical, expensive, and sometimes unethical using conventional video capture and recording techniques.

### SUMMARY

In one aspect, a method for monitoring kinetic motion characteristics includes: capturing acceleration data of a human body of interest from a plurality of points on the human body of interest; using the plurality of points that correlate to parts of the human body of interest to determine a position or view of the human body of interest, wherein the position or view includes a kinetic signature comprising motion characteristics; and displaying a live representation of the human body of interest by using the determined position or view of the human body of interest.

In another aspect, a method for monitoring kinetic motion characteristics includes: coupling sensors to a plurality of points on a human body of interest; capturing acceleration data from the sensors on the human body of interest; using the plurality of points that correlate to parts of the human body of interest to determine a position or view of the human body of interest, wherein the position or view includes a kinetic signature comprising motion characteristics; and capturing physiological data; displaying a live representation of the human body of interest by using the determined position or view of the human body of interest; and using the physiological data to add context when displaying the live representation of the human body of interest.

In yet another aspect, a system for monitoring kinetic motion characteristics includes: a central processing unit (CPU) that is configured to control operation of a gateway device; and one or more computer readable data storage media storing software instructions that, when executed by the CPU, cause the system to: capture acceleration data of a human body of interest from a plurality of points on the human body of interest; use the plurality of points that correlate to parts of the human body of interest to determine a position or view of the human body of interest, wherein the position or view includes a kinetic signature comprising motion characteristics; and display a live representation of the human body of interest by using the determined position or view of the human body of interest.

### DESCRIPTION OF THE FIGURES

FIG. 1 illustrates an example personal monitoring system configured estimate an individual's overall status and health.

FIG. 2 illustrates various locations of sensor related equipment as disposed relative to a body of a soldier.

FIG. 3 illustrates a simplified diagram depicting various locations of sensors related equipment relative to the anatomy of a wearer of such equipment.

FIG. 4 illustrates various body positions of a soldier.

FIG. 5 illustrates additional body positions of a soldier.

FIG. 6 illustrates a plurality of soldiers having locations arranged into different formations.

FIG. 7 illustrates additional soldiers having locations arranged into different formations.

FIG. 8 illustrates an example method for collecting, processing, and classifying kinetic and physiological data collected from the individual.

FIG. 9 illustrates an example method of classifying kinetic data using a rule-based system.

### DETAILED DESCRIPTION

The present disclosure relates to systems and methods that operate independent of an image sensor and are capable of predicting movement of one or more individuals in a geographic area from a remote station. The corroboration of kinetic and physiological data can provide an accurate assessment of the individual's overall status and health.

One embodiment includes systems and methods for monitoring kinetic motion characteristics, including capturing acceleration data of a human body of interest from a plurality of points on the human body of interest, using the plurality of points that correlate to parts of the human body of interest to determine a position or view of the human body of interest, wherein the position or view includes a kinetic signature comprising motion characteristics; and displaying a live representation of the human body of interest.

In examples described herein, the movement of the human body captured by the systems and methods includes one or more primitive sensory-motor actions involving one or more of the user's limbs, head, or torso such that a positive acceleration value is registered. An activity is a group of primitive movements in temporal succession, and an activity level is a measurement of energy expenditure (or some other metric) of an activity.

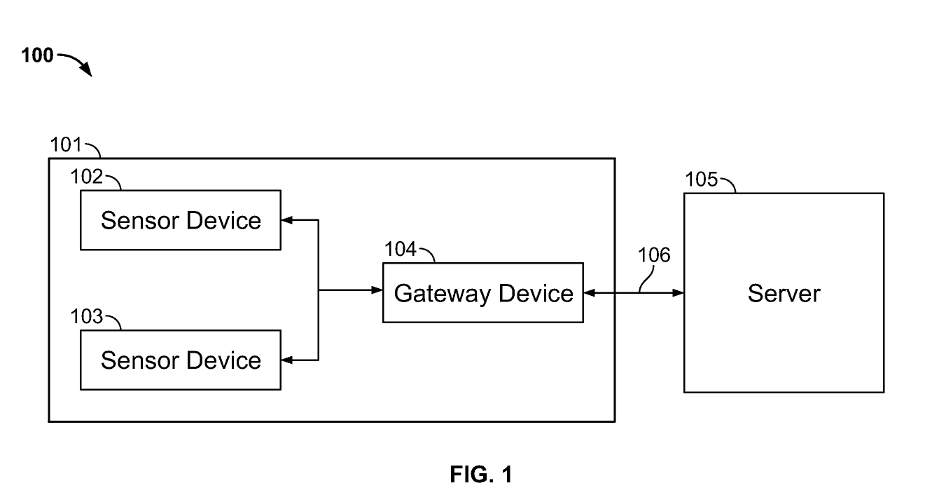

Referring now to FIG. 1, an example personal monitoring system 100 configured to provide an estimate of an individual's overall status and health is shown.

The system 100 includes a plurality of sensor devices 102, 103 connected to a gateway device 104 to form a personal status monitor 101. As described further below, the sensor devices 102, 103 are configured to collect kinetic and/or physiological data from an individual. The sensor devices 102, 103 and the gateway device 104 are carried on the individual.

The gateway device 104 sends the collected data over a network 106 to a server 105. The server 105 can process the data and provide an estimate of the individual's body position and health status.

In this example, the server 105 is a computing system. As used herein, a computing system is a system of one or more computing devices. A computing device is a physical, tangible device that processes data. Example types of computing devices include personal computers, standalone server computers, blade server computers, mainframe computers, handheld computers, smart phones, special purpose computing devices, and other types of devices that process data.

The server 105 can include at least one central processing unit (“CPU” or “processor”), a system memory, and a system bus that couples the system memory to the CPU. The system memory is one or more physical devices that can include a random access memory (“RAM”) and a read-only memory (“ROM”). A basic input/output system containing the basic routines that help to transfer information between elements within the server 105, such as during startup, is stored in the ROM. The system memory of the gateway device further includes a mass storage device. The mass storage device is able to store software instructions and data.

The mass storage device and its associated computer-readable data storage media provide non-volatile, non-transitory storage for the server 105. Although the description of computer-readable data storage media contained herein refers to a mass storage device, such as a hard disk or CD-ROM drive, it should be appreciated by those skilled in the art that computer-readable data storage media can be any available non-transitory, physical device or article of manufacture from which the server 105 can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 105.

The system memory of the server 105 can store software instructions and data. The software instructions include an operating system suitable for controlling the operation of the server 105. The system memory also stores software instructions, that when executed by the CPU, cause the server 105 to provide the functionality of the server 105 discussed herein.

For example, the mass storage device and/or the RAM can store software instructions that, when executed by the CPU, cause the server 105 to process the kinetic and physiological data from the sensor devices 102, 103 to estimate movement and health status of the individual.

The network 106 can include routers, switches, mobile access points, bridges, hubs, storage devices, standalone server devices, blade server devices, sensors, desktop computers, firewall devices, laptop computers, handheld computers, mobile telephones, and other types of computing devices. In various embodiments, the network 106 includes various types of links. For example, the network 106 can include wired and/or wireless links. The network 106 can be implemented as one or more local area networks (LANs), metropolitan area networks, subnets, wide area networks (such as the Internet), or can be implemented at another scale. In the example shown, the network 106 is a cellular or WiFi network. Other configurations are possible.

In examples described herein, the individual is a soldier. In other examples, the individual is a patient, such as an ambulatory patient in a hospital. In yet another example, the individual is a tennis player. The concepts described herein are applicable to individuals undergoing a variety of different activities, from daily living to hospital care to intensive activities like sports or combat.

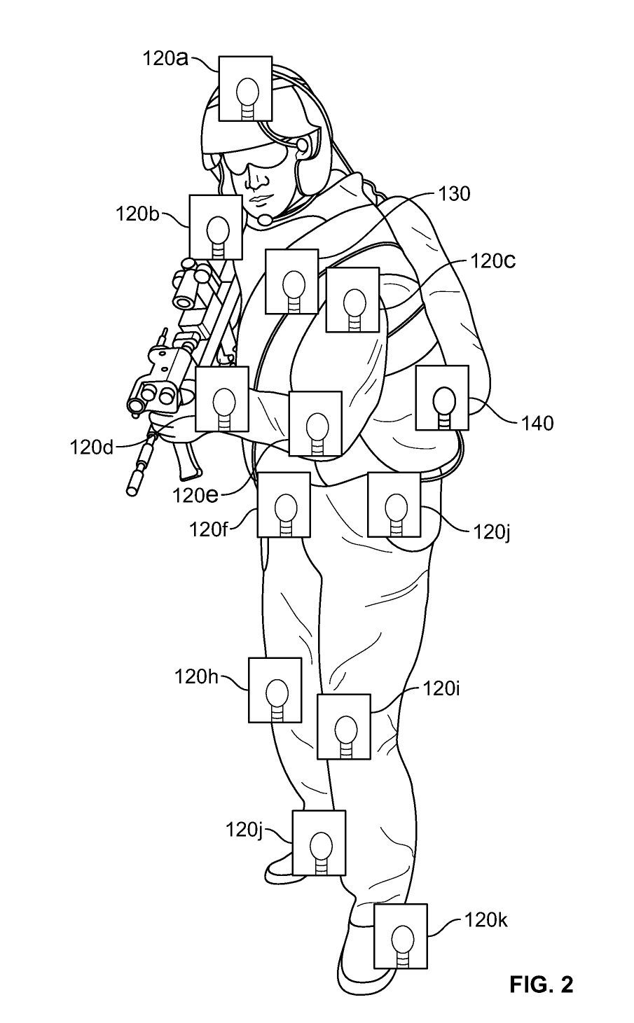

FIG. 2 illustrates various locations of sensors related equipment as disposed relative to a body of a soldier 110.

As shown, the soldier 110 is standing and dressed in military fatigues, wearing a helmet and holding a rifle. In this embodiment, there are eleven kinetic sensors 120a-120k that are each disposed proximate to a location along the surface of the body of the soldier 110. Each of the kinetic sensors 120a-120k is designed to measure a real-time attribute of a portion of the soldier's body to which the kinetic sensor is located proximate to.

Each of the kinetic sensors 120a-120k provides output data/information that is utilized by the personal monitoring system 100. The personal monitoring system 100 can include other sensory devices, such as devices that monitor physiological status and location status of one or more personnel. In addition, other numbers of sensors, such as eleven or less sensors, can be used. The system 100 can be configured to automatically configure analysis of the data from the sensors based on the type and number of sensors used.

The personal monitoring system 100 also includes at least one physiological sensor 130, and a gateway or gateway device 140 that together comprise a body area network (BAN) or personal area network (PAN).

Kinetic sensors 120a-120k include a variety of types of monitoring devices. Exemplary kinetic sensors include gyroscopes for acquiring physical orientation data and accelerometers for acquiring motion and acceleration data. The model MMA7660FC 3-Axis Orientation/Motion Detection Sensor available from Freescale Semiconductor, Inc., for example, can be used to acquire acceleration data.

Physiological sensor(s) 130 can further monitor and supply information regarding skin and core body temperature, motion tolerant non-invasive blood pressure, pulse rate, motion tolerant oxygen saturation (SpO₂), side-stream carbon dioxide levels (CO₂), digital auscultation, 3- to 12-lead ECG with interpretive software, calorie burn, heat load, respiration rate, and lung capacity/output, for example.

Information from kinetic sensors 120a-120k is processed in order to construct a visual-like and/or graphical representation of body status, motion and posture. Such a representation can be displayed in the form of a sensor driven avatar system. Information from physiological sensor(s) 130 is processed in order to communicate, such as by display in the avatar system, movement classification, physiological classification, and health classification of a soldier being monitored.

In one example, the avatar is anatomically accurate but plays pre-recorded animation files of human motions to mimic the motions of the monitored individual. In another example, the avatar is a wire-frame stick figure that accurately mimics the motions of the monitored person. Other configurations are possible.

Information received from a plurality of sensors 120a-120k and 130 located within the body area network supplies the avatar driven system. Sensor supplied information is received and processed (e.g. transmitted and/or analyzed) by the gateway device 140.

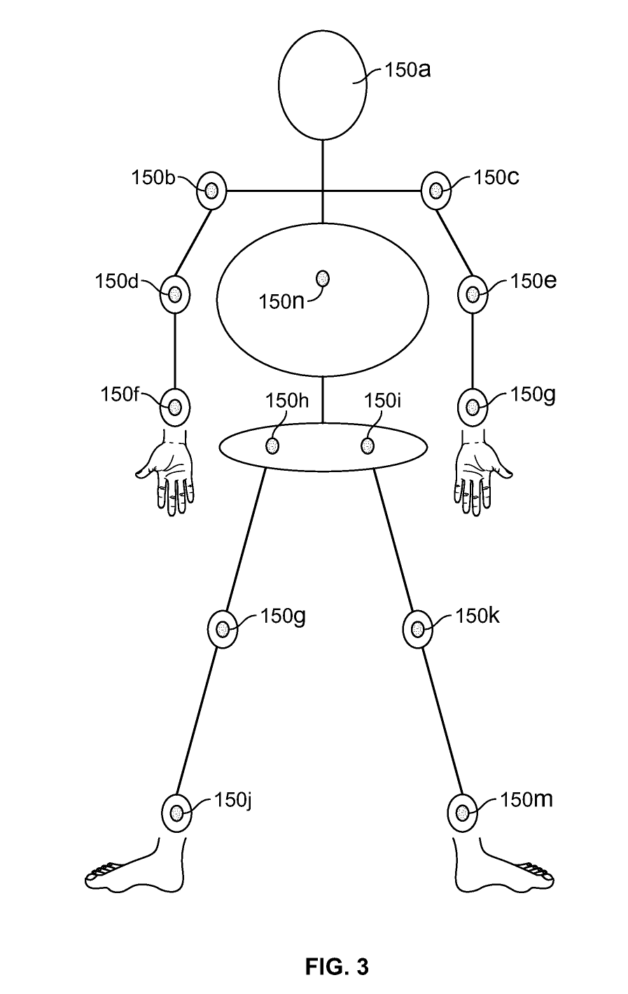

The kinetic sensors 120a-120k can be placed in any number of locations but are preferably disposed proximate to human joints and, even more preferably, as shown in FIG. 3, at thirteen (13) locations including those corresponding with the shoulders, elbows, wrists, hips, knees, ankles and chest. In the arrangement of FIG. 3, the locations 150a-150m for kinetic sensors are capable of providing full motion characteristics used to determine a range of situational and physical status conditions and/or classifications.

Each of the kinetic sensors 120a-120k and physiological sensor(s) 130 are configured to communicate with the gateway device 140 such as by a transceiver configured to wirelessly communicate data (e.g. physical orientation, acceleration, heart rate etc.) to the gateway device 140, or, more preferably, direct electrical connectivity to the gateway device 140 such as by wired connection or, even more preferably, through one or more textile-based buses embedded in the garment, for example.

One exemplary textile bus is disclosed in U.S. Pat. No. 7,559,902 entitled “Physiological Monitoring Garment” and incorporated herein by reference. The textile bus disclosed by the '902 Patent is a data/power bus and, accordingly, in one embodiment, the kinetic sensors 120a-120k can receive power from the gateway device 140 over the data/power textile bus. In another embodiment, each of the kinetic sensors 120a-120k includes its own power source, such as a battery for example, and yet other embodiments include various permutations of power-sharing arrangements.

The gateway device 140 includes, preferably, a low power microprocessor, data storage and a network interface. The data storage includes local and/or network-accessible, removable and/or non-removable and volatile and/or nonvolatile memory, such as RAM, ROM, and/or flash. The network interface can be an RS-232, RS-485, USB, Ethernet, Wi-Fi, Bluetooth, IrDA or Zigbee interface, for example, and preferably comprises a transceiver configured for, in one embodiment, wireless communication allowing for real-time transmission of kinetic and/or physiological data.

In another embodiment, the network interface is configured to transmit intermittently and, in yet another embodiment, the network interface is configured to transmit only when prompted. In those embodiments including wireless communication, it is preferable to transmit encrypted data and at radio frequencies, if utilized, that have reduced risk of detection by other than the intended recipient (e.g. a remote monitoring station as discussed below). To allow for delayed transmission of acquired data, the data storage can optionally be configured to store the acquired data at least until prompted to communicate the data to the network interface.

In one embodiment, the data storage of the gateway device 140 can be configured to store program instructions that, when implemented by the microprocessor, are configured to analyze the acquired kinetic and/or physiological data to determine a movement classification and/or health status of an individual. In another embodiment, the data storage means of the gateway device 140 is configured to store program instructions that, when implemented by the microprocessor, are configured to receive data from the plurality of kinetic sensors 120a-120kand/or the physiological sensor(s) 130 and communicate with the network interface to transmit the acquired data to a remote monitoring station. Details regarding an example gateway device are provided in U.S. patent application Ser. No. ______, Attorney Docket No. 10156.0032US01, titled “Platform for Patient Monitoring” and filed on even date herewith, the entirety of which is hereby incorporated by reference.

In one exemplary embodiment, a soldier can wear a personal status monitor 101 of FIG. 3 including thirteen accelerometers disposed at locations 150a-150m. FIG. 3 illustrates a simplified diagram depicting locations 150a-150m that are suitable to dispose monitoring equipment relative to the anatomy of a wearer of such equipment.

As noted above, the server 105 receives the kinetic and/or physiological data collected by the sensor devices 120a-120k and forwarded by the gateway device 140. The server 150 is thereupon configured to store program instructions that, when implemented by the processor, are configured to analyze the received kinetic and/or physiological data to determine a movement classification and/or health status of an individual.

Exemplary body movement classifications can include running, walking, limping, crawling, and falling, among others, which describes the characteristics of the motion and includes a flowchart showing the methods of detection. Body position classifications can further include lying on the back and laying face down, among others.

In one embodiment, the data storage can further be configured to store program instructions configured to communicate the analyzed kinetic and/or physiological output data to the user of the remote monitoring station through the display. The communication of the data can be in the form of numerical values of sensor data, numerical and/or textual analysis of sensor data, and/or a sensor driven avatar system (SDAS) configured to integrate an array of body area network/personal area network sensors to derive and display at least one avatar model configured to represent the movements of the individual(s) wearing the personal status monitor 101. In an SDAS embodiment, the avatar model can be configured to graphically display movement classifications as calculated by the control unit and/or remote monitoring station and based on sensor output data.

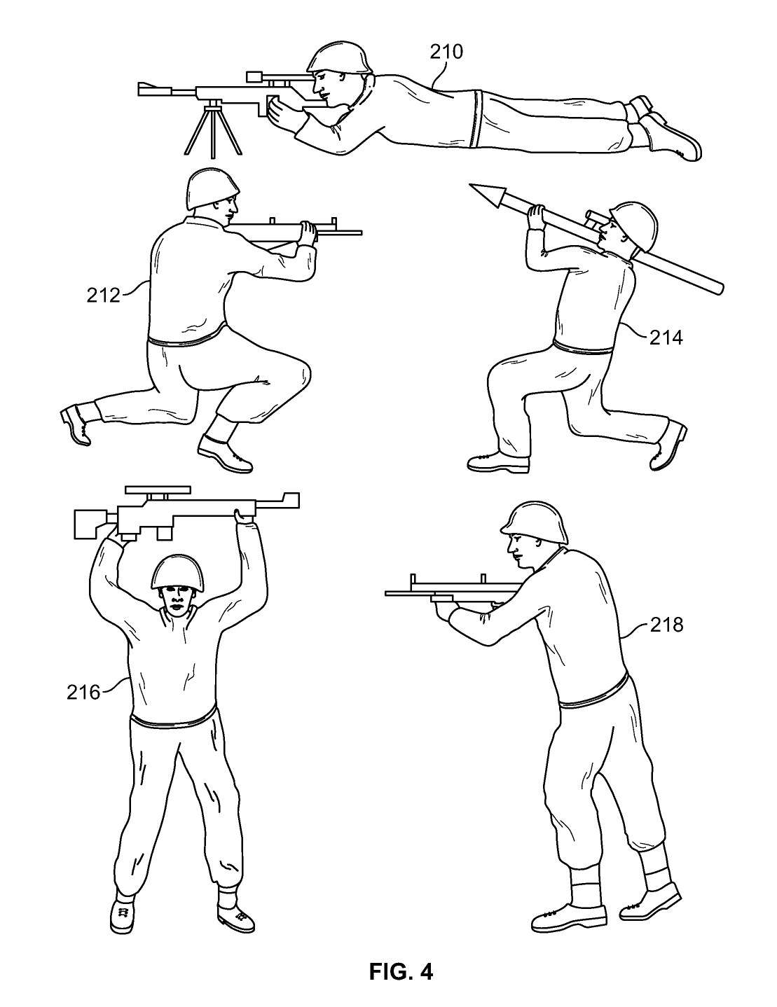

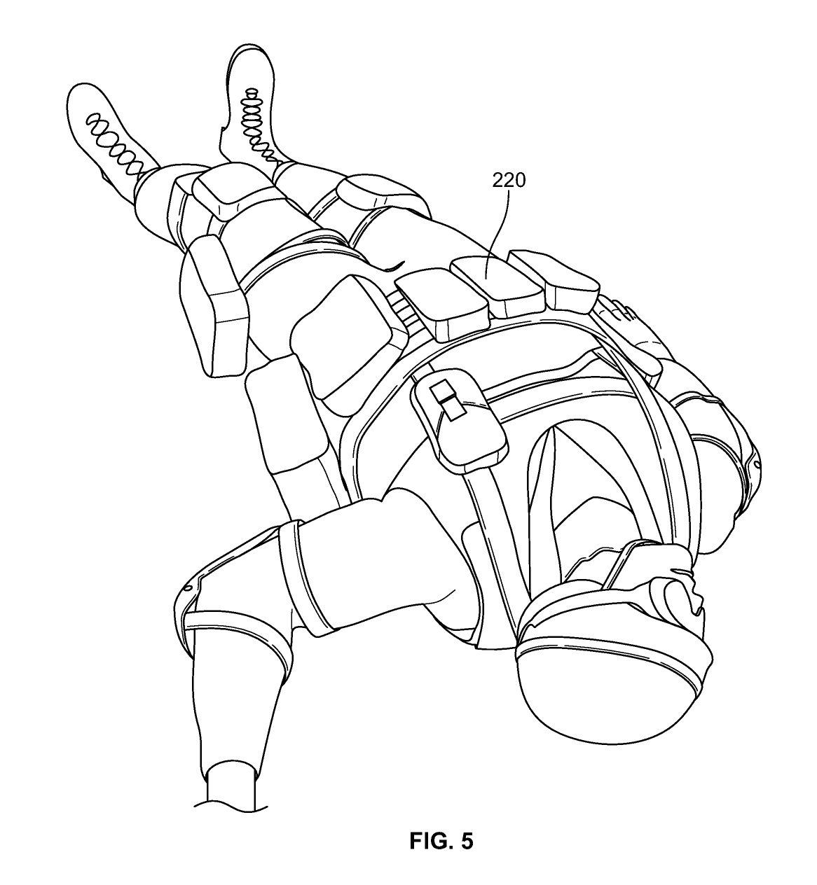

FIGS. 4 and 5 illustrate various body positions of a soldier. As shown, a first body position 210 shows a soldier lying on his stomach while his head is lifted off the ground. A second body position 212 shows a soldier kneeling in an upright position. A third body position 214 shows a soldier kneeling while his head is leaning backward. A fourth body position 216 shows a soldier standing while raising his arms. A fifth body position 218 shows a soldier standing while leaning forward and aiming a rifle. A sixth body position 220 shows a soldier lying on his stomach while a side of his head is making contact with the ground.

Remote monitoring of body position and body movement of one or more soldiers in the field, including such as the body positions described above, can provide valuable information to other military personnel who direct actions and assistance to those one or more soldiers in the field. Remote monitoring of body position provides a static form, while remote monitoring of body movement, provides a time dynamic type of information regarding the status of a soldier's body.

Detection of body position and/or motion can also be implemented via digital logic, such as that embodied within software. A microprocessor, residing local to the wearer, such as in the gateway device 140, can process and analyze the output data/information from kinetic sensors 120a-120k in order to determine body position (see FIGS. 4, 5) and body motion rapidly in time.

Alternatively, the server 105 (typically located remotely at a central station) can perform this function as described above allowing the field medic, or any other person having access to the remote monitoring station, to determine the motion characteristics of this soldier, along with any other soldier wearing a personal status monitor 101 of the present disclosure. Even more relevant to the field medic, the remote monitoring station can be configured to determine limb loss, tremors due to shock and extreme environmental conditions, posture, fatigue, gait, physical and concussive impact, weapons discharge, full body motion, and stride analysis, among other characteristics.

In another exemplary embodiment, the personal status monitor 101 includes physiological sensors 130 configured to measure heart rate and respiration. In this embodiment, the program instructions of the data storage of the remote monitoring station can be configured to determine mortality and/or unconsciousness, among other health statuses. The distinction between these exemplary physiological statuses and the movement classification of “laying face down” is enabled via such physiological sensors 130.

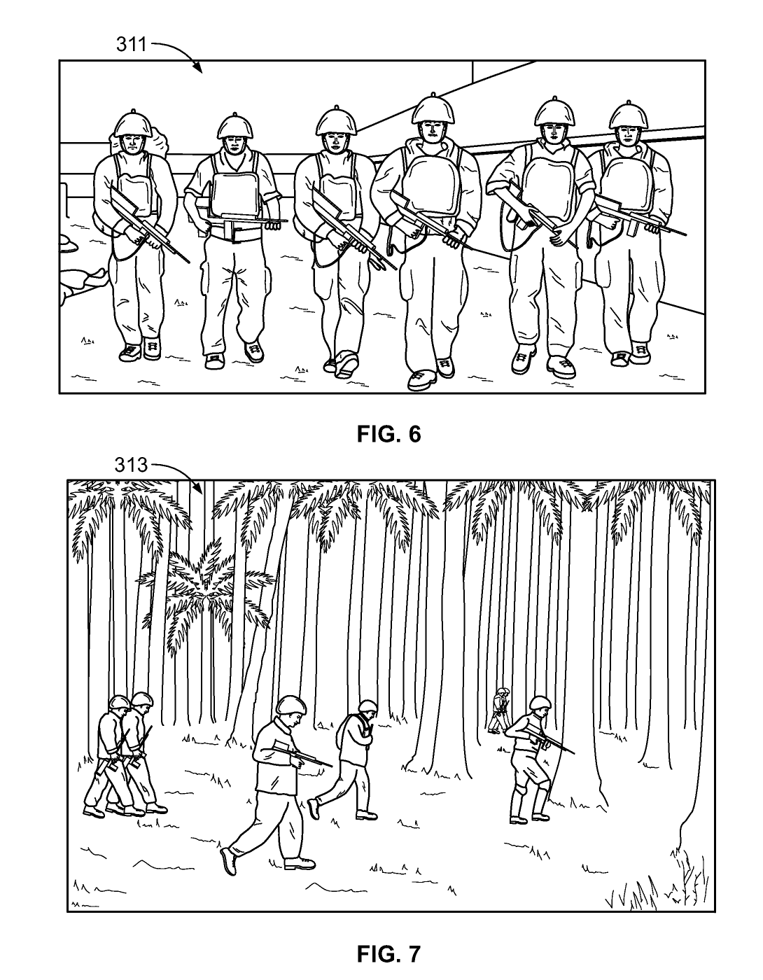

FIGS. 6 and 7 illustrate a plurality of soldiers 311, 313 having locations arranged in accordance with different formations.

Referring to FIG. 6, several soldiers are each wearing a personal status monitor 101 of the present disclosure. The personal monitoring system 100 can be configured to identify location characteristics such as by use of a global positioning system (GPS) integrated with the control unit. Accordingly, in this embodiment, differentiation between and/or identification of individuals wearing a personal status monitor 101 can be accomplished based on GPS coordinates (location status) transmitted to the remote monitoring station from the network interface of the gateway device 140 or, alternatively, a separate GPS module.

Alternatively, or in combination, each gateway device 140 can be configured to transmit a previously-assigned unique identifier, using the network interface, to the remote monitoring station. The data storage of the server 105 can then be configured to store a database configured to associate each individual with the unique identifier of his/her personal status monitor 101.

In some embodiments, captured acceleration data of a human body of interest from a plurality of points on the human body of interest, using the plurality of points that correlate to parts of the human body of interest to determine a position or view of the human body of interest, are used to generate a kinetic signature comprising motion characteristics. These characteristics are used to display a live representation of the human body of interest without incorporating a camera image by using the determined position or view of the human body of interest.

In some embodiments, the motion characteristics of the kinetic signature can include falling, running, limping, head movement, and stationary-status. Extrapolation of the one or more points is performed by an analytic engine executed on the server 105. The plurality of points provides a position of each of the human body of interest's extremities. Optionally, a movement of the live representation of the human body of interest directly correlates with actual movement of the human body of interest, preferably in real or near real time.

In some embodiments, a live representation of the human body of interest is computer generated. Optionally, the live representation of the human body of interest is a robotics platform or manifestation thereof.

In another aspect, a wearable physiological system provides image-like motion characteristics, the wearable physiological system comprising an array of embedded kinetic sensors that provide the image like motion characteristics; and a personal status processor that is integrated with the embedded kinetic sensors and capable of analyzing kinetic and physiological signals emitted from the embedded kinetic sensors. In some embodiments, the embedded kinetic sensors are located on a person's skin or embedded in clothing.

In some embodiments, the image like motion characteristics provide situational and physical status conditions corresponding to a person. In some embodiments, the person's situational and physical status conditions include running, walking, posture, direction, location, limb loss, mortality, consciousness, gait, predetermined vital signs, stride analysis, and weapons discharge. In some embodiments, the person's situational and physical status is processed and transmitted in real-time.

Optionally, the personal status processor is located on a belt. Also, optionally the embedded kinetic sensors located on the person's skin are integrated within a wearable patch. In some embodiments, the wearable patch is non-adhesive.

For military applications, the embedded kinetic sensors can be embedded in armor. Optionally, the embedded kinetic sensors are coupled communicatively to radar. In another aspect, a method for providing image like motion characteristics from a wearable physiological system comprising the steps of providing an array of embedded kinetic sensors that provide the image like motion characteristics; and integrating a personal status processor with the embedded kinetic sensors; and analyzing kinetic and physiological signals emitted from the embedded kinetic sensors.

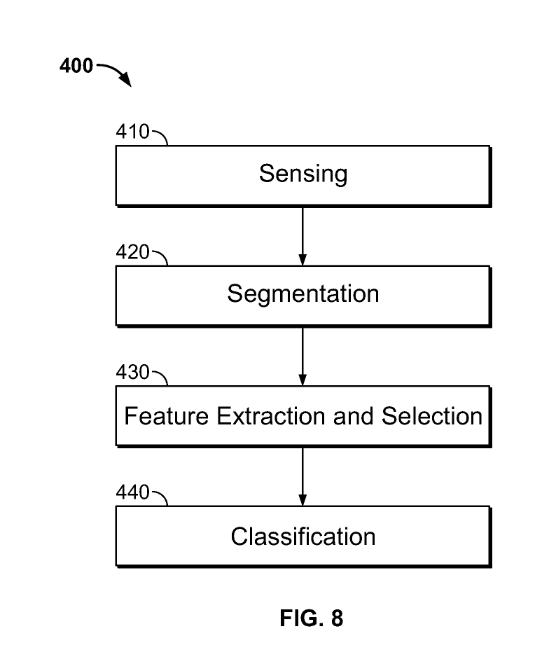

Referring now to FIG. 8, an example method 400 for collecting, processing, and classifying the kinetic and physiological data collected from the individual is shown.

Initially, at operation 410, data is acquired. Specifically, kinetic and/or physiogical measurements of the individual are taken using the sensors worn on the individual's body. As sensors come online, their anatomical position is assigned to one of the PSM compatible positions. Data arrives from the sensors at a pre-specified sampling rate. Sensor timing is initialized and synchronized to ensure the proper data arrival order from the multiple sensors. All on-board event handling and hardware filtering is enabled at this stage.

Next, at operation 420, the raw data is filtered and reconstructed. Software filtering is applied to the raw signal (e.g., low-pass filtering). The original signal is reconstructed from the readings that arrive. This is necessary when the sensors operate in a power-saving mode. For example, when there is no significant change in acceleration in burst mode, the accelerometers will not transmit any data. The original signal can be recovered because we know the data sampling rate. The original signal may then be segmented (i.e., partitioned) into portions of interest and background signal that we do not care about.

At operation 430, the data is processed and features are extracted. Basic features, such as mean, standard deviation, energy, peak, and signal magnitude area are extracted from regular chunks of the reconstructed signal. While features in time series are sufficient to discriminate between many motions and postures, it is sometimes necessary to extract features from the frequency domain (FFT, Wavelet features). If at this stage feature vectors are too large or too noisy for the classifier to operate efficiently, a feature selection algorithm (e.g., subset evaluation or principal component analysis) is performed to reduce the dimensionality of the vectors sent to the classifier. This often corresponds to selecting the most informative sensors for a given classification.

Finally, at operation 440, classifications are performed using unsupervised clustering or supervised learning techniques. Posture or motion is determined using an unsupervised or supervised classification algorithm on the basis of the feature-set generated in operation 430 and any contextual knowledge that can be brought to bear on the classification task. The output class and live sensor readings are stored in a database for further computation and/or are displayed for the user using an interface.

One example of another embodiment is an ambulatory patient monitoring application. In such an application, one or more sensor devices are connected across the xiphoid process with optional right hip, heart rate, and respiration rate sensors.

From the torso sensors, classifications including moving and stationary are made, as well as posture classifications including: upright, bending forward, and bending backward. An adverse event classification can also be made related to falls.

With the right hip sensor added, the following classifications can be made:
Motion: running, walking, stationary;
Posture: standing, sitting, bending forward, bending backward, lying face down, lying on back; and
Adverse Event: falls.

With the vital signs sensors added, warnings of sudden heart rate and/or respiratory rate increases can be monitored during certain motions, such as while stationary. This allows for contextualized vitals readings.

In implementation, the ambulatory patient monitoring application is primarily intended to provide a measure of overall patient ambulation and a mechanism for falls detection. A real-time, unsupervised, rule based algorithm is used to perform coarse-grained posture classification based on Euler angle features. A signal magnitude area feature is used to compute metabolic energy expenditure, a metric of overall activity.

Hidden Markov Models (HMMs) of activities of daily living (ADLs) are built by querying a patient population dataset and computing transition probabilities between different postures. For example, from the lying posture, the next posture will be sitting with higher probability than standing (since standing requires first that the patient sits up).

Falls are adverse, rare-but-relevant events that can appear to be statistical noise in very large datasets. As such, offline supervised fall-outcome based classification is used to determine if there are common ADL or vitals trajectories leading to fall events. Such patterns are searched for on a per-patient basis as well as across a patient population samples with common demographic/disease state context.

In another example, the concepts described herein can be used to analyze an individual's tennis serve. For such an application, four accelerometers are positioned at the wrist and elbow of each arm. An outcome prediction model can be built to make either immediate (serve-in or fault) or long term (point-won, point-lost) estimates.

To implement, serves are segmented from non-serves in a stream of motion. The serve signal is then divided into three components: onset, swing, and follow through. Ideally, this could be further subdivided into more serve primitive motions following a standard biomechanical model of effective serves, as illustrated in the figure below:

Optionally, feature selection is performed to determine the most informative sensor for a player's serve. Classification is used to learn the kinetic signature of desired outcome (e.g., serve in). The centroid of these positive outcomes in feature space is used as an ideal against which live serves are measured. This is done by measuring (and scoring) the distance in feature space between the live serve and the stored centroid.

One application of such an algorithm is in measuring the progress of a player's rehabilitation from an injury. As an injury heals, it is expected that the trajectory of serves in feature space will begin to converge towards positive outcomes.

Another application of such an algorithm is to try to detect nuanced motions and player synchronization/timing. In tennis, coaches are looking for the racket-drop to happen at the top of the player's jump and pronation of the wrist to occur as the ball is being struck. Such fine-grained events may require correlating the acceleration signal with video.

Such an algorithm could be adapted for use in other athletic contexts, such as batting practice, golf swings, bowling, and anything else involving form-based repetitive motions.

In the examples described above, data from the kinetic sensors are used to estimate a patient's movements, and data from the physiological sensors is used to put the data from the kinetic sensors in context.

As an example, data from the kinetic sensors can be used to estimate the following:
Stationary—all the sensors are static;
Walking—sensors on the legs have accelerations, and correlation between left leg and right leg is close to zero;
Running—sensors on the legs have larger accelerations, the acceleration direction is towards the sky, and correlation between left leg and right leg is close to zero;
Jumping—sensors on the legs have the same pattern of accelerations with cross-correlation being close to 1 and the direction of acceleration is toward the sky;
Tremors—acceleration has spring like pattern, with accelerations on the arm showing the same pattern, and correlation between left arm and right arm is close to 1—accelerations on the legs show the same pattern;
Unconsciousness—static, with additional context provided from any vital sign data; and
Mortality—no pulse.
   Injury status can be estimated using a supervised classification to identify the pattern of the acceleration data. For example, abnormal acceleration data associated with an arm or leg could indicate an injury on the arm or leg.

In one embodiment, the system 100 utilizes decision rule based classification to separate the arm motion from leg motion and develop the rules for each arm motion and leg motion. Advantages of decision rule based classification are that they are unsupervised and do not need training data and also take less computation time. However, some disadvantages are that they cause more false alarm error (if there is other motion, it will be classified into one of the categories), although this can be mitigated by a follow-up check of the similarity between some features, and limited motions can be characterized by a certain rule.

For example, for leg motions, it is easier to develop a certain rule by checking whether the accelerations on the left leg and that on the right leg are synchronized or have 180 latency to classify walk, run, and jump. When the leg motions and arm motions are identified, the activity of a person may be recognized. Accordingly, other embodiments utilize supervised classification algorithms to characterize certain motions, such as arm motions, not easily characterized by rules, as described further below.

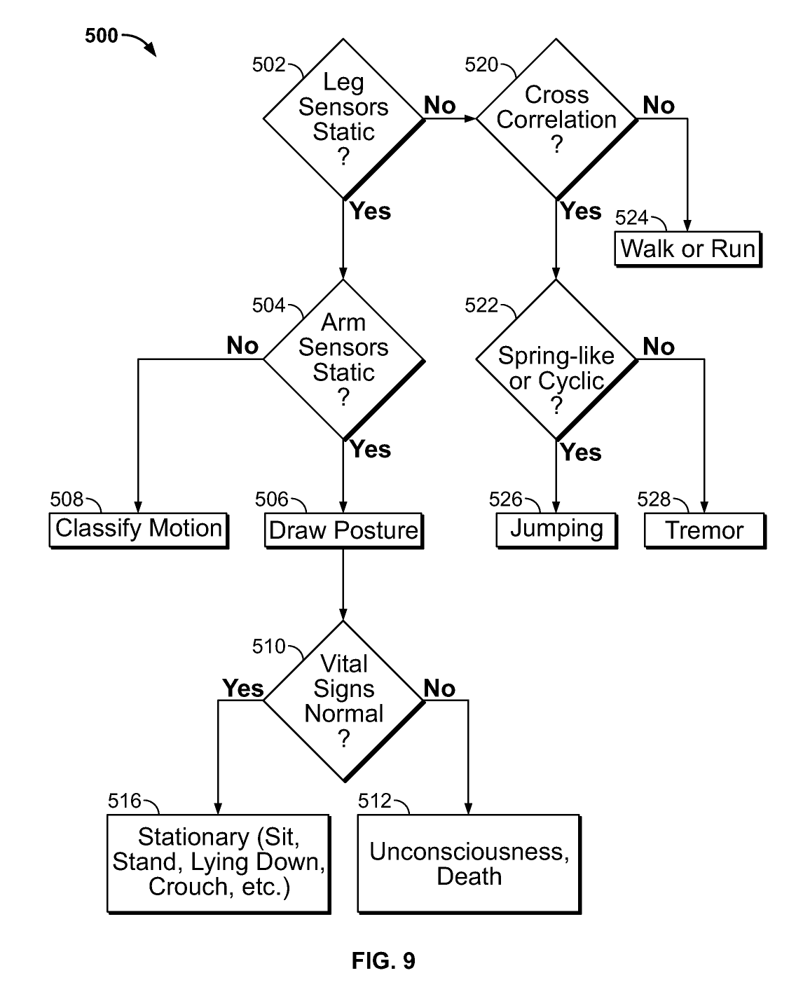

Referring now to FIG. 9, an example method 500 of classification using a rule-based classification system is shown. The method uses rules that act upon data from the kinetic and physiological sensor to estimate a status of an individual.

At initial operation 502, a determination is made regarding whether or not the sensors associated with the legs are static. If so, control is passed to operation 504.

At operation 504, a determination is made regarding whether or not the arm sensors are static. If not, control is passed to 508, and an attempt is made to classify the data associated with the movement indicated by the arms (e.g., firing of a weapon, etc.).

If the arm sensors are static, control is instead passed to operation 506, and the posture of the individual is estimated. See below for examples of posture estimation. Next, at operation 510, a determination is made regarding whether or not the individual's vital signs are normal based on the posture. If the vitals are normal, control is passed to operation 516, and an estimate of the posture (e.g., sitting, standing, lying down, crouching etc.) is provided. If not, an estimate of the individual's status, such as unconscious or dead, is provided at operation 512.

If the determination is made that the legs are not status at operation 502, control is passed to operation 520. At operation 520, a determination is made regarding whether or not the leg motion exhibits cross-correlation. If not, control is passed to operation 524, and an estimate of the individual walking or running is provided.

If there is cross-correlation, control is instead passed to operation 522 to determine if the accelerations are spring-like or cyclic. If yes, control is passed to operation 526, and an estimate of the individual jumping is provided. If not, control is passed to operation 528, and an estimate of tremors is provided. Other configurations are possible.

In yet another example, an embodiment can be used to classify posture of an individual. With respect to acceleration, a person is not always active. When the person is stationary, the posture can be determined from acceleration data. To perform a full-body posture classification, nine 3-axis accelerometers (e.g., the Freescale D3965MMA7660FC) are used.

One accelerometer is attached to the waist to measure torso posture. The Y axis of the accelerometer is aligned with the head and the Z axis is perpendicular to the torso. The remaining sensors are firmly attached to the four limbs to measure the posture of arms and legs, with two accelerometers on each limb. Two accelerometer planes on each limb are parallel to each other.

The Y axes of all nine accelerometers are aligned to the gravity line when the subject stands upright. As the accelerometers are used to calculate the relative angles between torso and limbs, the accelerometers are positioned such that the accelerometer plane is not easy to roll as the part of the limb rolls. For example, if the individual rolls an arm, the relative angle between the torso and arm does not change. Therefore, the accelerometer is positioned on the arm such that it is least affected by the roll of the arm. As the leg usually does not roll independently to the torso, we may attach the accelerometer either closer or further away from the hip joint. However, as the arm usually rolls easily, a position further away from the wrist is best for the accelerometer on the forearm and a position closer to the shoulder is best for the accelerometer on the upper arm since accelerometers at these two positions will be least affected by the roll of the arm.

In the body posture model, the body posture is defined by a total of nine angles. The orientations of the accelerometers on the limbs represent the orientations of the limbs, i.e., the relative angle between the torso and limb can be represented by the relative angle between accelerometer on the torso and accelerometer on the limb. To obtain the nine angles, the Euclidean coordinate system is converted to the Euler angle coordinate system for each accelerometer reading. The Euler angle coordinate system is used to describe the orientation of a rigid body with respect to three angles in three-dimensional space.

When the subject is stationary, the accelerometer only senses the acceleration due to gravity, and therefore, based on the accelerometer reading in three axes, the Euler angles of the three axes can be computed: (1) pitch—the angle of the x axis relative to the ground; (2) roll—the angle of the y axis relative to the ground, and (3) yaw—the angle of z axis relative to the gravity line.

The Euler angles of each accelerometer are used to calculate the relative angles of one pair of accelerometers. As the Y axis of the accelerometer is along the limb, it always “follows” the orientation of the limb, i.e., roll of the limb does not change the direction of Y axis. Therefore, the relative angle between Y axis of two accelerometers is used to obtain the relative angle between torso and limb or between different parts of limb.

The full body posture can be drawn based on the nine angles calculated from the acceleration data. This information can be used to develop a real-time algorithm that enables automatic clustering on a continuous posture sequence for the unsupervised model acquisition. The algorithm is based on the assumption that static postures can be viewed as repetitive sequence and the posture data has very small variation within a short period. Maximum likelihood methods, such as K-mean algorithm provides effective tools for clustering. The algorithm creates a new cluster when there are enough accumulated agglomerative data, and adaptively updates the cluster model while labeling the data.

The posture sequence consists of two states, transition state (motion) and posture state (static). The posture state is defined as when the data has small variation within a short period. Thus, when there is new data received at the sensor, the data is buffered, and clustering is performed only when the next several data samples have small standard deviation and therefore is considered in posture state. When the data is considered in the posture state, the Chebyshev distance to each cluster centroid is first calculated. Then the data is assigned to the cluster that it is within the bound of the cluster. Every time when there is a new data assigned to a cluster, the Gaussian model of this cluster is updated by recalculating the mean and standard deviation of all the data belonging to this cluster. If the data is outside the bound of any cluster, it is collected in a temporary buffer for new cluster.

When there are enough data in the temporary buffer for a new cluster, and there is small variation in the data, a Gaussian model is learned from the data in the temporary buffer and a new cluster is created. There is a limit for total number of data in each cluster and a limit for total number of clusters. For the cluster where the number of data reach the limit, the oldest data is removed. When the total number of clusters reaches the limit, the cluster that was not updated recently is removed. In this way, the clusters can be adapted and learn the cluster models. The algorithm can be completely data-driven, does not require a training data set, and therefore, it can be used to monitor a person's long-term status.

The various embodiments described above are provided by way of illustration only and should not be construed as limiting. Those skilled in the art will readily recognize various modifications and changes that may be made without following the example embodiments and applications illustrated and described herein, and without departing from the true spirit and scope of the disclosure.

What is claimed is:

1. A method for monitoring kinetic motion characteristics, comprising:
capturing acceleration data related to movement of a human body of interest from a plurality of points on the human body of interest;
using the plurality of points that correlate to parts of the human body of interest to determine a position or view of the human body of interest, wherein the position or view includes a kinetic signature comprising motion characteristics; and
displaying a live representation of the human body of interest by using the determined position or view of the human body of interest.

2. The method of claim 1, further comprising coupling eleven sensors to the human body of interest to capture the acceleration data.

3. The method of claim 1, further comprising:
capturing physiological data; and
using the physiological data to add context when displaying the live representation of the human body of interest.

4. The method of claim 3, further comprising estimating a status of a soldier as the human body of interest.

5. The method of claim 4, further comprising estimating a health state of the soldier.

6. The method of claim 3, further comprising estimating an acceleration of the human body of interest.

7. The method of claim 6, further comprising:
estimating a posture of the human body of interest; and
estimating a health state of the human body of interest.

8. The method of claim 1, further comprising classifying a motion associated with the human body of interest.

9. The method of claim 8, further comprising:
measuring an acceleration of arms and legs of the human body of interest;
when the legs and arms are static, classifying a posture of the human body of interest;
when the legs or arms are moving, classifying the motion.

10. The method of claim 9, further comprising, when the legs are not moving in a cross-correlated fashion, determining that the human body of interest is walking or running.

11. The method of claim 9, further comprising:
measuring an angle of each sensor that is coupled to the human body of interest to capture the acceleration data; and
estimating the posture based on the angle of each sensor.

12. A method for monitoring kinetic motion characteristics, comprising:
coupling sensors to a plurality of points on a human body of interest;
capturing acceleration data from the sensors on the human body of interest;
using the plurality of points that correlate to parts of the human body of interest to determine a position or view of the human body of interest, wherein the position or view includes a kinetic signature comprising motion characteristics;
capturing physiological data;
displaying a live representation of the human body of interest by using the determined position or view of the human body of interest; and
using the physiological data to add context when displaying the live representation of the human body of interest.

13. The method of claim 12, further comprising estimating a status of a soldier as the human body of interest.

14. The method of claim 13, further comprising estimating a health state of the soldier.

15. A system for monitoring kinetic motion characteristics, comprising:
a central processing unit (CPU) that is configured to control operation of a gateway device; and
one or more computer readable data storage media storing software instructions that, when executed by the CPU, cause the system to:
capture acceleration data of a human body of interest from a plurality of points on the human body of interest;
use the plurality of points that correlate to parts of the human body of interest to determine a position or view of the human body of interest, wherein the position or view includes a kinetic signature comprising motion characteristics; and
display a live representation of the human body of interest by using the determined position or view of the human body of interest.

16. The system of claim 15, further comprising coupling eleven sensors to the human body of interest to capture the acceleration data.

17. The system of claim 16, wherein the software instructions executed by the CPU further cause the system to:
capture physiological data; and
using the physiological data to add context when displaying the live representation of the human body of interest.

18. The system of claim 17, wherein the software instructions executed by the CPU further cause the system to estimate a status of a soldier as the human body of interest.

19. The system of claim 18, wherein the software instructions executed by the CPU further cause the system to estimate a health state of the soldier.

20. The system of claim 17, wherein the software instructions executed by the CPU further cause the system to:
estimate a posture of the human body of interest; and
estimate a health state of the human body of interest.
